(19) United States
(12) Patent Application Publication
(10) Pub. No.: US 2022/0108702 A1
(43) Pub. Date: Apr. 7, 2022

(54) SPEAKER RECOGNITION METHOD

(71) Applicant: NATIONAL YUNLIN UNIVERSITY OF SCIENCE AND TECHNOLOGY, Yunlin County (TW)

(72) Inventors: Jeng-Shin SHEU, Douliu City (TW); Liang-Wei SHIU, Douliu City (TW)

(21) Appl. No.: 17/061,267

(22) Filed: Oct. 1, 2020

(51) Int. Cl. G10L 17/10; G10L 17/08; G10L 17/18; G10L 17/26

(52) U.S. Cl. CPC G10L 17/10; G10L 17/26; G10L 17/18; G10L 17/08

(57) ABSTRACT

The invention provides a speaker recognition method, which comprises three stages of recognition. The first-stage recognition is to detect whether a text-dependent test statement is a spoofing attack of the replay. The second-stage recognition is to detect whether a text-independent test statement is a spoofing attack of the synthetic speech. The third-stage recognition is to judge which registered speaker speaks the text-independent test statement by a speaker recognition system. If it is not spoken by the registered speaker, it is directed to an imposter. The first two stages use different features with different binary classifiers, and the third stage uses a complex classifier to determine the text-independent is spoken by target or imposter through Ensemble Learning and Unanimity Rule with conditional retry mechanism. Therefore, the rate of blocking the target can be effectively reduced without losing the rate of blocking the impostor.

### FIELD OF THE INVENTION

The present invention relates to a speech technology, and in particular to a speaker recognition method.

### BACKGROUND OF THE INVENTION

With the increasing number of voice application products, the speaker recognition technology becomes important. It needs to authenticate the identity of the speaker and prevent impersonation, so as to meet the requirements of anti-theft and confidentiality.

In particular, with the maturity of technologies such as Speech Synthesis and Voice Conversion, the voice attack has also become an important issue to be resolved by the speaker recognition technology. In the speaker recognition, who provides the test statements that meet what the registered speaker spoke, is called a target; and who provides the test statements that do not meet what the registered speaker spoke, is called an imposter. Besides, attacks with artificial fake voices (trying to pass authentication) are called spoofing attacks, including replay, speech synthesis and voice conversion. Replay refers to replaying pre-recorded statement what the registered speaker spoke, while speech synthesis and voice conversion refer to providing fake voice generated by an artificial technology.

The speaker recognition technology needs to correctly recognize the targets and prevent the spoofing attack and the intrusion of the imposter. In order to judge the quality of the speaker recognition technology, the Logical Access (LA) corpus provided by ASVspoof-2019 can be used as the training/testing corpus set. ASVspoof-2019 is automatic speaker recognition and countermeasure competition initiated by University of Edinburgh, French Institute for Research in Computer Science and Automation (INRIA), NEC and other organizations, and the competition is divided into two major challenges: LA and Physical Access (PA). LA corpus has 107 authentic speakers, including 46 males and 61 females, and the speech has no obvious channel noise or background noise.

In practical applications, first of all, it is unlikely to find a feature extraction technology that can simultaneously distinguish “replay”, “synthetic speech” and “human speech”. In addition, in the application of the speaker recognition, any non-registered speaker is the imposter, so the number of imposters is far greater than the number of targets, and malicious imposters may even try to break into the system for a plurality of times. Considering above two situations, the abilities of selecting the appropriate feature engineering, accepting entry of all targets, and blocking any imposters are the key to successfully implement the speaker recognition technology.

Known speaker recognition technology, such as the paper “Speaker Verication using I-vector Features” published by PhD Thesis. Or paper “Front-End Factor Analysis for Speaker Verification” published by Najim Dehak, etc. on IEEE TRANSACTIONS ON AUDIO, SPEECH, AND LANGUAGE PROCESSING, VOL. 19, NO. 4, MAY 2011. Or paper “Joint Factor Analysis versus Eigenchannels in Speaker Recognition” published by Patrick Kenny, etc. on IEEE Transaction on Audio Speech and Language Processing, VOL. 15, NO. 4, MAY 2007: 1435-1447. Neither can effectively solve the problem of spoofing attacks, nor solve the problem of imposters trying to rush.

In addition, the known method used to detect the replay attack is the key acoustic feature of the development, but currently no sufficiently robust feature can block the replay completely. The known feature of detected synthetic speech is extracted as Constant Q Cepstral Coefficients (CQCC), however, this feature still cannot provide complete information to develop the ability of fully recognizing the synthesized statement. For distinguishing the targets and the imposters, the known feature extraction technology is i-vector.

The spoofing attacks for replaying and artificially synthesized statement are the known detection issues of the binary classification. Regarding the recognition technology of the known targets and the imposters, a threshold value decision-making method is mostly adopted, such as Deep Neural Networks (DNN), Linear-Support Vector Machine (SVM), Kernel-SVM and Random Forest and other classifiers. The classifier generates a score for the test statement. When the score is higher than the threshold value, it is judged to be passed (the test statement is spoken by the target), and if the score is lower than the threshold value, it is judged to be not passed (the test statement is spoken by the imposter). This threshold value decision-making method has a tradeoff between “increasing the rate of blocking the imposter” and “reducing the rate of blocking the target”, that is, no threshold value can meet these two efficiencies at the same time.

Therefore, the known score normalization method is used to pull the score distribution between the target and the impostor, hoping to find an appropriate threshold value more easily. However, in the practical applications, the score normalization method still cannot improve the rate of accepting the target and the rate of blocking the imposter at the same time. This is because the score distribution of the target and the impostor is partially overlapped, and the score normalization method cannot separate the distribution of two scores.

### SUMMARY OF THE INVENTION

The main objective of the present invention is to provides a speaker recognition method, which can detect the spoofing attack of the replay and speech synthesis. At the same time, for the speaker recognition, the rate of blocking the target can be reduced effectively without losing the rate of blocking the imposter.

To achieve the foregoing objective, the present invention provides a speaker recognition method to recognize a text-dependent test statement and a text-independent test statement spoken by a user. The text-dependent test statement is the designated statement, and the text-independent test statement is the statement that is spoken at will.

The present invention sequentially performs a first-stage recognition, a second-stage recognition, and a third-stage recognition to determine whether the text-dependent test statement is a spoofing attack of a replay, and whether the text-independent test statement is a spoofing attack of a synthetic speech, and the speaker recognition system judges that the text-independent test statement is a target or a imposter. The speaker recognition method comprises the following steps:

The first stage of recognition is to determine whether the text-dependent test statement is the spoofing attack of the replay by a binary classifier, wherein the binary classifier is formed by a text-dependent speech recognition model in conjunction with speech recognition or template matching selectively, and the text-dependent speech recognition model is constructed by features of Mel-frequency Spectral Coefficients (MFSC), and wherein if the text-independent test statement is the spoofing attack of the replay, the text-dependent test statement is rejected; and if not, the first-stage recognition is passed.

The second-stage recognition is to determine whether the text-independent test statement is the spoofing attack of the synthetic speech by another one binary classifier, wherein the binary classifier receives a hybrid feature, which is constructed by reducing dimensionality of the text-independent test statement, and the hybrid feature is a hybrid feature vector constructed by Constant Q Cepstral Coefficients (CQCC) and Spectrogram of the text-independent test statement; and wherein if the hybrid feature is the synthetic speech, the text-dependent test statement is rejected; and if not, the second-stage recognition is passed.

The third-stage recognition is to determine that the text-independent test statement is spoken by a target or an imposter, and wherein the third-stage recognition performs the following steps by a text-independent speaker recognition system with a plurality of registered speakers and a plurality of classifiers.

Step (a): extracting i-vector features of the text-independent test statement and reducing dimensionality of i-vector features, and based on i-vector features after dimension reduction, commanding the plurality of classifiers respectively judges that the text-independent test statement is spoken by any one of the plurality of registered speakers or the imposter to generate a judgment result separately;

Step (b): making a decision based on the judgment results, wherein if all the judgment results are directed to the same registered speaker, the text-independent test statement is judged as spoken by the target, and the third-stage recognition is finished; if numbers of judgment results directed to the same registered speaker is less than half, the text-independent test statement is judged as spoken by the imposter, and the third-stage recognition is finished; and if numbers of judgment results directed to the same registered speaker is not the total number but not less than half, Step (c) is continued; and

Step (c): giving a retry opportunity with a limit number of times, wherein if numbers of the retry opportunity does not exceed the limit number of times, the text-independent speaker recognition system requests the user to re-speak another text-independent test statement, then Step (a) is repeated; and if numbers of the retry opportunity exceeds the limit number of times, the third-stage recognition is finished, and the text-independent test statement is judged as spoken by the imposter.

According to the above description, as to the spoofing attack of the replay, the text-dependent speech recognition model is constructed by the features of Mel-frequency Spectral Coefficients (MFSC) and is in conjunction with speech recognition or template matching to form the binary classifier. The binary classifier determines whether the text-dependent test statement is the spoofing attack of the replay. As to the spoofing attack of the synthetic speech, it is determines by another one binary classifier based on a hybrid feature, which is constructed by reducing dimensionality of the text-independent test statement. Regarding the speaker recognition of the target and the imposter, it provides the plurality of classifiers to judge the same text-independent test statement. The text-independent test statement is judged as spoken by the target only if the plurality of judgment results is all directed to the same registered speaker; and if not, the retry opportunity with a limit number of times. Therefore, by giving aforementioned retry opportunity with a limit number of times, the rate of blocking the imposter is not lost. At the same time, the wrong blocking of the target can be solved effectively, the target is prevented from being mistaken regarded as an imposter, and the rate of blocking the target is reduced effectively.

### BRIEF DESCRIPTION OF THE DRAWINGS

FIG. 1 is a system flow diagram of the speaker recognition method of the present invention.

FIG. 2 is a schematic diagram for generating the hybrid feature vector.

FIG. 3 is a schematic diagram for recognizing the recognition input speech of the present invention.

### DETAILED DESCRIPTION OF THE PREFERRED EMBODIMENTS

The detailed description and technical content of the present invention are described below with reference to the accompanying drawings.

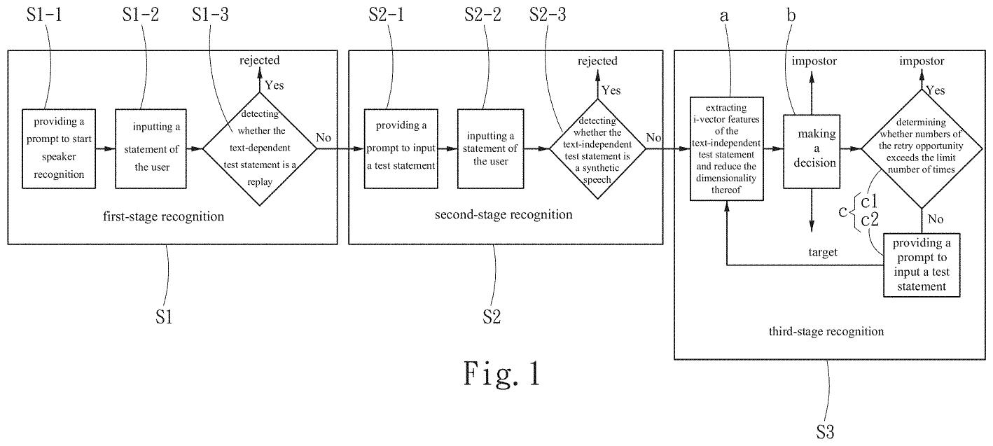

Referring to FIG. 1, in a preferred embodiment, a speaker recognition method provided by the present invention can recognize a text-dependent test statement and a text-independent test statement spoken by a user. The speaker recognition method comprises following steps: a first-stage recognition S1, a second-stage recognition S2, and a third-stage recognition S3.

In detail, the first-stage recognition Si further comprises Step S1-1, Step S1-2, and Step S1-3, and Step S1-1 provides a prompt to start speaker recognition. In one embodiment, Step S1-1 is realized by a system that sends a voice message to notify the user of starting the recognition. What is being done at this time is to recognize the text-dependent statement, but the system does not prompt that this recognition is a text-dependent statement test or a text-independent statement test. For an imposter, he/she does not know the content of the text-dependent test statement.

Step S1-2 is to input a statement of the user. In Step S1-2, it waits for the user to speak and generates the text-dependent test statement.

Step S1-3 is to detect whether the text-dependent test statement is a replay. In Step S1-3, it determines whether the text-dependent test statement is a spoofing attack of the replay. In detail, a text-dependent speech recognition model is constructed by features of Mel-Frequency Cepstral Coefficients (MFSC). The speech recognition model is selected in conjunction with Speech Recognition or Template Matching to form a binary classifier, which determines whether the text-dependent test statement is the spoofing attack of the replay. If the text-dependent test statement is the spoofing attack of the replay, the text-dependent test statement is rejected, and the recognition process is finished; and if not, the first-stage recognition is passed, and the second-stage recognition S2 is entered.

The second-stage recognition S2 further comprises Step S2-1, Step S2-2, and Step S2-3, and the step S2-1 provides a prompt to input a test statement. In Step S2-1, the system sends another voice message to notify the user of starting speaking and generating the text-independent test statement. The input of the text-independent test statement is not limited to be a text-dependent statement, but can be the statement that is spoken at will which is irrelevant to the text.

Step S2-2 is to input a statement of the user. In Step S2-2, it waits for the user to speak and generates the text-dependent test statement.

Step S2-3 is to detect whether the text-independent test statement is a synthetic speech. In order to determine whether the text-independent test statement is the spoofing attack of the synthetic speech, Step S2-3 constructs a hybrid feature by reducing the dimensionality of the text-independent test statement, and transmits the hybrid feature to another one binary classifier to determine whether the hybrid feature is the synthetic speech. The hybrid feature is a hybrid feature vector constructed by Constant Q Cepstral Coefficients (CQCC) and Spectrogram of the text-independent test statement. After determination, if the hybrid feature is the synthetic speech, the text-dependent test statement is rejected, and the recognition process is finished; and if not, the second-stage recognition S2 is passed, and the third-stage recognition S3 is entered.

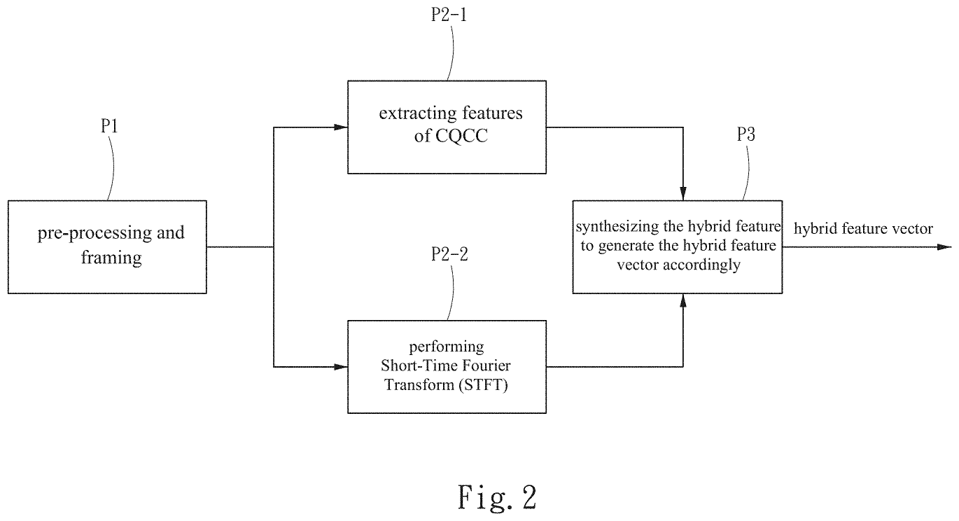

Refer to FIG. 2, which is a schematic diagram for generating the hybrid feature vector. The text-independent test statement performs Step P1: pre-processing and framing, and then separately performs the step P2-1: extracting features of CQCC and step P2-2: performing Short-Time Fourier Transform (STFT), and finally performs step P3: synthesizing the hybrid feature to generate the hybrid feature vector accordingly. The feature of CQCC is a conventional voice feature, which combines the voice features obtained by Constant Q Transform and the traditional cepstrum process.

The third-stage recognition S3 further comprises Step (a), Step (b), and Step (c). In order to determine whether the text-independent test statement is a target or an imposter, the third-stage recognition S3 performs Step (a), Step (b), and Step (c) by a text-independent speaker recognition system with a plurality of registered speakers and a plurality of classifiers.

Specifically, Step (a) is to extract i-vector features of the text-independent test statement and reduce the dimensionality thereof. In Step (a), it extracts i-vector features of the text-independent test statement, and commands the plurality of classifiers respectively judges that the text-independent test statement is spoken by any one of the plurality of registered speakers or the imposter by i-vector features after dimension reduction and generates a judgment result separately. In detail, i-vector is a conventional voice feature dimensionality-reduced technology, which is mainly realized based on a Joint Factor Analysis (JFA) method. It can reduce the dimensionality of voice features with different lengths and fix them to the same length, and the technology is often used in speech recognition. The number of the plurality of classifiers used in the method of the present invention is preferably an odd number. In one embodiment of the present invention, it uses five classifiers, which are One-model Deep Neural Networks (One-model DNN), Multi-model Deep Neural Networks (Multi-model DNN), Linear-Support Vector Machine (Linear-SVM), Kernel-Support Vector Machine (Kernel-SVM) and Random Forest.

Step (b) is to make a decision based on the plurality of judgment results. The present invention adopts a judgment method of ensemble learning in unanimity way to judge that the text-independent test statement is spoken by the target or the imposter. Specifically, the ensemble learning is to integrate different classifiers. In this embodiment, it is to integrate the five classifiers as described above. If all the judgment results are directed to the same registered speaker, the text-independent test statement is judged as spoken by the target, and the third-stage recognition is finished. If the number of judgment results directed to the same registered speaker is less than half, the text-independent test statement is judged as spoken by the impostor, and the third-stage recognition is finished. If the number of judgment results directed to the same registered speaker is not the total number but not less than half, Step (c) is continued.

Step (c) is to give a retry opportunity with a limit number of times. Step (c) mainly comprises Step (c1) and Step (c2). Step (c1) is to determine whether the number of the retry opportunity exceeds the limit number of times. If the number of retry opportunity does not exceed the limit number of times, Step (c2) is continued, and Step (c2) provides a prompt to input a test statement. Step (c2) allows the user to re-speak another text-independent test statement and repeat from Step (a) again. In step (c1, if the number of retry opportunity exceeds the limit number of times, the third-stage recognition S3 is finished, and the text-independent test statement is judged as spoken by the imposter. In addition, for security consideration, in one embodiment, the number of retry opportunity is no more than twice, and when the text-independent test statement is judged as spoken by the imposter, the speaker recognition system will send a warning message to a manager of the speaker recognition system and lock the speaker recognition system. At the same time, unless the user unlocks the speaker recognition system, the speaker recognition system can only be restarted after a preset period of time.

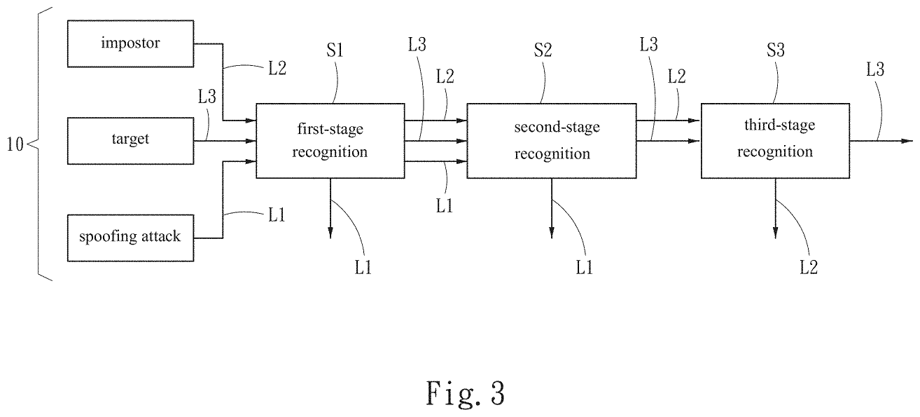

Referring to FIG. 3, the user speaks an input speech 10. The input speech 10 comprises the text-dependent test statement and the text-independent test statement. The input speech 10 may be input from a target, a spoofing attack including replay and synthetic speech, or an imposter, which is respectively represented in L3, L1, or L2 of FIG. 3 as a best-state path recognized by the method of the present invention. Most of the spoofing attacks of the replay and the synthetic speech can be recognized and excluded in the first-stage recognition S1 and the second-stage recognition S2, as shown in L1 of FIG. 3. Most of the imposters can be recognized and excluded in the third-stage recognition S3, as shown in L2 of FIG. 3. However, most of the targets can be recognized through the first-stage recognition S1, the second-stage recognition S2, and the third-stage recognition step S3, as shown in L3 of FIG. 3.

In one simulation test of the present invention, it recruits 20 targets, 20 spoofing attacks and 67 imposters. Each target has 25 test statements, each spoofing attack has 450 test statements, and each imposter has 65 test statements. The simulation test is divided into “no retry mechanism” (no retry opportunity is given), “retry mechanism” (a retry opportunity is given) and “conditional retry mechanism” (a retry opportunity with the limit number of times is given), and after performing for 10,000 times, the averaged data is as shown in the table below.

| | No retry | Retry | Conditional retry |
|---|---|---|---|
| | mechanisin | mechanisin | mechanisin |
| Rate of blocking | 10% | 1.7% | 3.3% |
| the target | | | |
| Rate of blocking | 92.5% | 86.7% | 92.5% |
| the imposter | | | |
| rate of blocking | 97.5% | 95.3% | 97.5% |
| the spoofing | | | |
| attack | | | |

Compared with no retry mechanism, since the retry mechanism is not limited, namely retrying until the result converges, the rate of blocking the imposter will decrease, which means that the imposter is more likely to be misjudged as the target. And compared no retry mechanism with the conditional retry mechanism, the rates of blocking the imposter and spoofing attack are similar, but the rates of the blocking target under the conditional retry mechanism is decreased significantly, so that more targets will not be misjudged as the imposters. Therefore, the conditional retry mechanism of the present invention can reduce the rate of blocking the target effectively without losing the rate of blocking the imposter and the spoofing attack.

In summary, the present invention has the following features:

I. The present invention provides a conditional retry mechanism cooperated with the unanimity rule, so the rate of blocking the target can be reduced effectively without losing the rate of blocking the imposter.

II. The speaker recognition is carried out by the text-dependent test statement and the text-independent test statement, so that the trying rush of the spoofing attack is solved effectively.

What is claimed is:

1. A speaker recognition method, recognizing a text-dependent test statement and a text-independent test statement spoken by a user and comprising the following steps:
a first-stage recognition, determining whether the text-dependent test statement is a spoofing attack of a replay by a binary classifier, wherein the binary classifier is formed by a text-dependent speech recognition model in conjunction with speech recognition or template matching selectively, and the text-dependent speech recognition model is constructed by features of Mel-frequency Spectral Coefficients (MFSC), and wherein if the text-independent test statement is the spoofing attack of the replay, the text-dependent test statement is rejected; and if not, the first-stage recognition is passed;
a second-stage recognition, determining whether the text-independent test statement is a spoofing attack of a synthetic speech by another one binary classifier, wherein the binary classifier receives a hybrid feature, which is constructed by reducing dimensionality of the text-independent test statement, and the hybrid feature is a hybrid feature vector constructed by Constant Q Cepstral Coefficients (CQCC) and Spectrogram of the text-independent test statement; and wherein if the hybrid feature is the synthetic speech, the text-dependent test statement is rejected; and if not, the second-stage recognition is passed; and
a third-stage recognition, determining that the text-independent test statement is spoken by a target or an imposter, and wherein the third-stage recognition performs the following steps by a text-independent speaker recognition system with a plurality of registered speakers and a plurality of classifiers:
Step (a): extracting i-vector features of the text-independent test statement and reducing dimensionality of i-vector features, and based on i-vector features after dimension reduction, commanding the plurality of classifiers respectively judges that the text-independent test statement is spoken by any one of the plurality of registered speakers or the imposter to generate a judgment result separately;
Step (b): making a decision based on the judgment results, wherein if all the judgment results are directed to the same registered speaker, the text-independent test statement is judged as spoken by the target, and the third-stage recognition is finished; if numbers of judgment results directed to the same registered speaker is less than half, the text-independent test statement is judged as spoken by the imposter, and the third-stage recognition is finished; and if numbers of judgment results directed to the same registered speaker is not the total number but not less than half, Step (c) is continued; and
Step (c): giving a retry opportunity with a limit number of times, wherein if numbers of the retry opportunity does not exceed the limit number of times, the text-independent speaker recognition system requests the user to re-speak another text-independent test statement, then Step (a) is repeated; and if numbers of the retry opportunity exceeds the limit number of times, the third-stage recognition is finished, and the text-independent test statement is judged as spoken by the imposter.

2. The speaker recognition method of claim 1, wherein when the text-independent test statement is judged as spoken by an impostor, the speaker recognition system sends a warning message to a manager of the speaker recognition system and lock the speaker recognition system; and wherein unless the user unlocks the speaker recognition system, the speaker recognition system only be restarted after a preset period of time.

3. The speaker recognition method of claim 1, wherein the number of the retry opportunity is not more than twice.

4. The speaker recognition method of claim 1, wherein the number of the plurality of classifiers is odd.

5. The speaker recognition method of claim 4, wherein the number of the plurality of classifiers is five, which are One-model Deep Neural Networks (One-model DNN), Multi-model Deep Neural Networks (Multi-model DNN), Linear-Support Vector Machine (Linear-SVM), Kernel-Support Vector Machine (Kernel-SVM) and Random Forest.
